(19) United States
(12) Patent Application Publication
(10) Pub. No.: US 2020/0139799 A1
(43) Pub. Date: May 7, 2020

(54) SEALING MODULE FOR A MOTOR VEHICLE AND MOUNTING THEREOF

(71) Applicant: HUTCHINSON, Paris (FR)

(72) Inventors: Olivier Blottiau, Cepoy (FR); Eddy Skraburski, Montargis (FR); Robert McDonald, Commerce Township, MI (US); Jack Tallent, Farmington Hills, MI (US)

(73) Assignee: HUTCHINSON, Paris (FR)

(21) Appl. No.: 16/608,155

(22) PCT Filed: Apr. 25, 2018
(86) PCT No.: PCT/FR2018/051050

§ 371 Date: Oct. 24, 2019

(30) Foreign Application Priority Data
Apr. 25, 2017 (FR) 1753558

(51) Int. Cl. B60J 10/273; B60R 11/04; B60J 10/74; B60R 16/02; B60R 16/023; B60J 10/00; B60J 5/04

(52) U.S. Cl. CPC B60J 10/273; B60R 11/04; B60J 10/74; B60R 2011/0026; B60R 16/023; B60J 10/45; B60J 5/0468; B60R 16/0207

(57) ABSTRACT

A sealing module for a motor vehicle, comprising at least one elongated profile and at least one seal configured to cooperate with a window of the vehicle, and further comprising a support for supporting at least one electronic equipment, such as a camera. The support can be integral with the profile.

### TECHNICAL FIELD

The present invention concerns in particular a sealing module for a motor vehicle, and its mounting, for example for the manufacturing of a vehicle door.

### BACKGROUND

The state of the art includes document FR-A1-2 858 950.

By definition, a sealing module for a motor vehicle is a modular element that is intended to provide a tightness, for example against water. In the context of this application, the element is intended to cooperate in the tightness with at least one other element, such as a fixed or movable window of the vehicle, to prevent the passage of water or dirt between the element and the window. The element is modular because it is designed to facilitate its mounting on the framework of a door or vehicle, by a worker of a car manufacturer for example. A “module” or modular element is a set of precedingly assembled parts or portions intended to be delivered to a manufacturer for use and mounted as such on a framework of the vehicle or of the door of the vehicle.

There are several types of vehicle sealing modules available. This can be for example a fixed window sealing module, a sealing strip, a slide, etc.

A fixed window sealing module for a motor vehicle is intended to form a fixed part of a vehicle door and generally comprises a frame at least partially surrounding a fixed window. This frame comprises at least one profile that extends along an edge of the window and extends beyond that edge to form a guide profile for a sliding window of the door.

FIG. 1 shows a motor vehicle 10 with front doors 12 and rear doors 14 equipped with such modules 16, 16′.

The sealing module 16 of the front door is generally located at the front of the front door 12. The fixed window 17 of the module 16 is intended to be arranged in a space E1 delimited by a slide 18 on the one hand, and by a sealing strip 20 on the other hand. The sealing strip 20 extends horizontally and comprises a seal 22 cooperating with an outer surface of a sliding window 24 of the door 12. The slide 18 comprises two vertical strands 18a, 18b the upper ends of which are connected to each other by a horizontal strand 18c. The slide 18 can also comprise a front strand 18d in the extension of the upper horizontal strand 18c, this front strand extending substantially downward and forward. The space El is delimited by an upper portion of the front vertical strand 18a, the front strand 18d, and a front portion of the sealing strip 20. In some variants, the front strand 18d is not part of the slide 18, but is directly integrated into the frame of the fixed window of the module 16. The fixed window 17 here has a general triangular shape and the above-mentioned profile 26 of the frame of this window extends along a vertical rear edge of the window 17, along the vertical front strand 18a. In particular, this front vertical strand 18a can be fixed on the profile, for example by being engaged in a longitudinal groove of the profile.

Similarly, the sealing module 16′ of the rear door is generally located at the rear of the rear door 14. The window 17′ of the module 16′ is intended to be arranged in a space E2 delimited by a slide 28 on the one hand, and by a sealing strip 30 on the other hand. The sealing strip 30 extends horizontally and comprises a seal 32 cooperating with an outer surface of a sliding window 34 of the door 14. The slide 28 comprises two vertical strands 28a, 28b, the upper ends of which are connected to each other by a horizontal strand 28c. The slide 28 can also include a rear strand 28d in the extension of the upper horizontal strand 28c, this rear strand extending substantially downward and rearward. The space E2 is bounded by an upper portion of the rear vertical strand 28a, possibly the rear strand 28d, and a rear portion of the sealing strip 30. The fixed window 17′ has a general trapezoidal shape (but may have another half-moon, rectangular or triangular shape along the style line of the vehicle) and the above-mentioned profile 26′ of the frame of this window extends along a front vertical edge of the window 17′, along the rear vertical section 28a. In particular, this rear vertical strand 28a can be fixed to the profile, for example by being engaged in a longitudinal groove of the profile.

Traditionally, a motor vehicle door is equipped with a mirror. A mirror can be mounted on the fixed window module of the door. In this case, the mirror is mounted at the end of the door construction, i.e. after mounting the fixed window module, the slide, the sealing strip, the sliding window, its actuating motor, etc. on the framework of the door.

A motor vehicle door can be equipped with an electronic equipment, such as a camera, a turn signal repeater, a proximity radar, etc. As with the mirror, this equipment is usually mounted at the end of the door construction.

There are disadvantages in the current technology. Indeed, the mounting step of the electronic equipment is an additional step in the construction of the door, which can be long and complex for the fixing of this equipment and its electrical connection to the electrical circuit of the vehicle. It requires the manufacturer to manage many different components.

The invention proposes an improvement to this technology, which provides a simple, effective and cost-effective solution to the above-mentioned problem.

### SUMMARY OF THE INVENTION

The invention proposes a sealing module for a motor vehicle, this module comprising at least one profile of at least partially elongated shape and at least one seal configured to cooperate with an element of said vehicle, such as a window of said vehicle, characterized in that it further comprises means for supporting at least one electronic equipment, such as a camera, which are integral with said profile.

In this application, an elongated profile is defined as a part that has a constant or inconsistent shape in cross-section over its entire length or longitudinal dimension. This type of part can be produced by extrusion, to have a constant shape in cross-section, but can also be produced by injection moulding to have an evolutionary shape in cross-section, two specific consecutive shapes in cross-section, etc.

The invention thus proposes to integrate the means for supporting an electronic equipment, or even the electronic equipment itself, into the sealing module. It is therefore understood that these support means will be mounted on the framework of the door at the same time as the sealing module, which makes it possible to eliminate a step of the prior art, and thus represents a significant time saving for the realization of a complete door.

The module according to the invention may include one or more of the following characteristics, taken in isolation from each other or in combination with each other:
said joint extends at least partially along said profile,
said profile is a hubcap comprising at least one outer surface intended to be visible to a user of said vehicle,
said module is a window sealing strip, said seal being configured to cooperate with a sliding window of said vehicle,
said profile comprises a boss on said outer surface, in which said electronic equipment is to be housed,
said profile and said joint are made by co-extrusion, multi-injection or overmoulding, or are pre-assembled,
said module comprises a frame at least partially surrounding a fixed window, said profile being part of said frame or attached to said frame, and preferably pre-mounted on or partially encased by it,
said profile extends along an edge of said fixed window and extends beyond that edge to form a guide profile for guiding a sliding window of said vehicle,
said support means are at least partially formed in one piece with said profile,
said support means comprises a support arm which has a generally elongated shape and comprises a first longitudinal end connected to said profile and an opposite second longitudinal end in which said electronic equipment is to be housed,
the module comprises a cover attached to the arm and comprising a longitudinal portion extending along the arm and/or a base covering a part of said window,
the module further comprises an electronic equipment mounted on or in said support means; it is therefore understood that the means for supporting the electronic equipment, but also the electronic equipment itself, are integrated into the sealing module, which is particularly advantageous for reducing the time required to produce a door for example,
said electronic equipment comprises at least one sensor, preferably contactless,
said electronic equipment comprises at least one optical sensor; the sensor can be both contactless and optical,
said electronic equipment is or comprises a camera, a turn signal repeater, a signal or information detection sensor, or a proximity radar,
said electronic equipment is connected to a first end of an electrical cable, an opposite second end of the latter is connected to at least one electrical connection plug; this makes it easier to connect the equipment electrically, the equipment being located, for example, outside the door or vehicle and its connection plug being, as soon as the sealing module is mounted, placed inside the door or vehicle,

The present invention also concerns a method of manufacturing a motor vehicle door, by means of a module as described above, comprising a step of mounting said module equipped with said support means, or even said electronic equipment, on a framework of said vehicle or a door of said vehicle.

Advantageously, the method comprises a subsequent step of mounting a slide on said door framework, for guiding a sliding window of said door, said slide comprising a vertical strand fixed to said profile of said module.

When the module comprises an electrical connection plug as described above, said support means are located on an outer side of said door, and said plug is located on an inner side of said door.

In a particular embodiment of the invention, the method comprises a step of mounting a fixed window module without its hubcap, a step of pre-mounting the hubcap (a connector part is slid into a corresponding part of a profile of the module), a step of mounting a slide (and in particular a slide vertical strand), and a step of permanently snap-fastening the hubcap over the slide vertical strand.

The present invention still concerns a motor vehicle, comprising at least one sealing module as described above. The sealing module is for example a fixed window module on a door or body (in one part or two parts, i.e. with a hubcap attached or not), a sealing strip, a slide, a frame seal that ensures a tightness between a door and the framework of the vehicle, an open roof seal, a windscreen seal, a rear window seal, etc.

### DESCRIPTION OF THE FIGURES

The invention will be better understood and other details, characteristics and advantages of the invention will appear when reading the following description, which is given by way of non-limiting example and by reference to the attached drawings, in which:

FIG. 1 is a schematic perspective view of a motor vehicle, as well as various sealing elements or modules of its doors,

FIGS. 2a and 2b are partial schematic views in perspective of a sealing module according to a first embodiment of the invention,

FIGS. 3a and 3b are partial schematic views of a profile and means for supporting an electronic equipment, of the module of FIGS. 2a and 2b,

FIGS. 4a and 4b are schematic perspective views of a cover of the module of FIGS. 2a and 2b,

FIG. 5 is a partial schematic view in perspective of a sealing module according to a second embodiment of the invention,

FIG. 6a is a partial, perspective and partially exploded schematic view of the module of FIG. 5,

FIG. 6b is a schematic perspective view of the hubcap and the electronic equipment of the module of FIG. 5,

FIG. 6c is another partial schematic view in perspective of the hubcap and the electronic equipment of the module in FIG. 5,

FIGS. 7a to 7c are partial schematic views in perspective of a sealing module according to a third embodiment of the invention,

FIG. 8 is a partial schematic view in perspective of a sealing module according to another variant of embodiment of the invention,

FIG. 9 is a schematic cross-sectional view of a sealing module of the sealing strip type,

FIGS. 10a and 10b are similar views to the one of FIG. 1 and show examples of electronic equipment installed on sealing modules of the vehicle,

FIG. 11 is a schematic view in perspective of a sealing module according to another variant of embodiment of the invention,

FIG. 12 is a larger scale view of a part of FIG. 11, and

FIG. 13 is a schematic cross-sectional view of a sealing module of the frame joint type.

### DETAILED DESCRIPTION

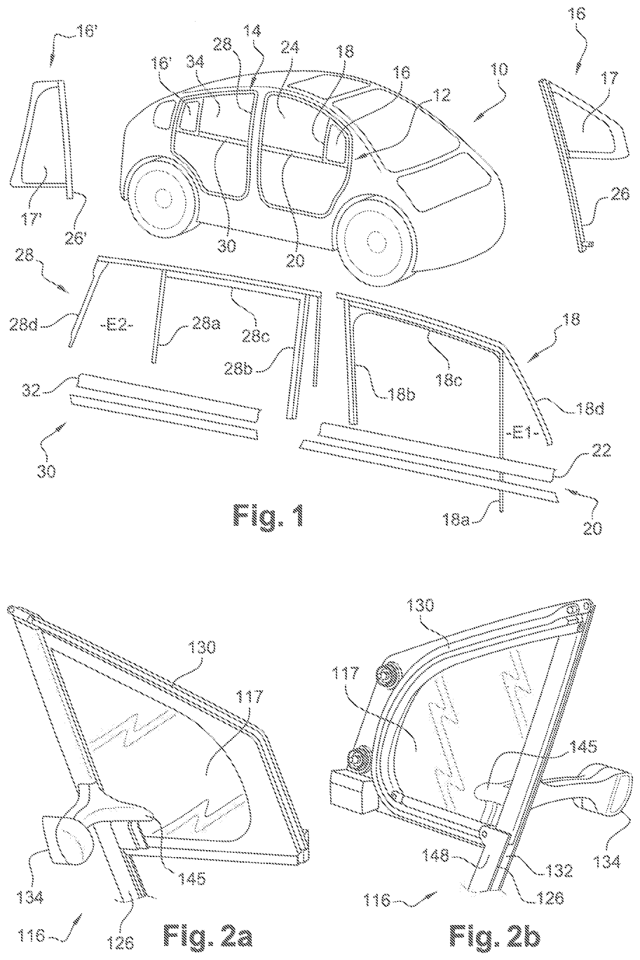

FIG. 1 has been described above.

FIGS. 2a to 4b illustrate a first embodiment of the invention.

The sealing module 116 comprises a frame 130 surrounding a fixed window 117 and comprising at least one profile 126 extending along an edge of the window and extending beyond this edge to form a guide profile for guiding a sliding window of a vehicle door. The frame 130 comprises or is equipped with a seal cooperating with the fixed window 117.

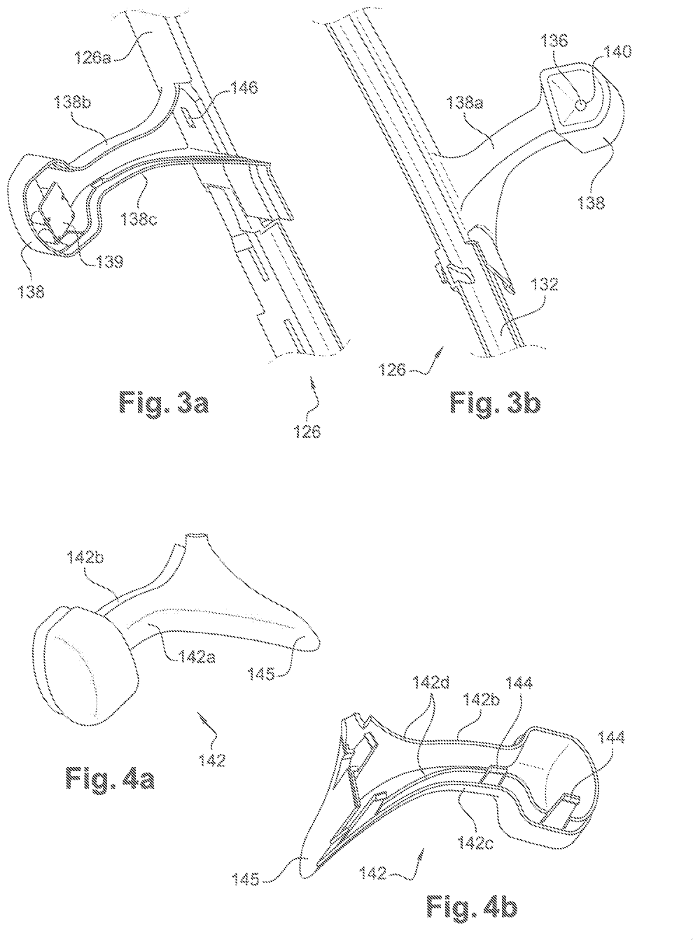

The window 117 has a general trapezoidal shape here but could have any other shape. The profile 126 extends along the large base of the window and has a general U-shaped cross-section to define a longitudinal groove 132, better visible in FIG. 3b. A vertical strand of a slide is intended to be housed in this groove 132, this vertical strand being intended to cooperate tightly with the sliding window of the door.

The profile 126 is formed in one piece with a first part of means 134 for supporting an electronic equipment 136, which is for example a camera.

This first part is in the form of an elongated arm 138, one longitudinal end of which is connected to the profile 126, and an opposite longitudinal end of which is free and carries the electronic equipment 136.

The arm 138 protrudes from the profile. It extends substantially along a longitudinal axis that is substantially perpendicular to the longitudinal axis of the profile 126 and/or the plane of the window 117.

The arm 138 has a general U-shaped cross-section, i.e. it is open here towards the front. It comprises a rear wall 138a, and two side walls, upper 138b and lower 138c respectively. The upper wall 138b is connected to a side wall 126a of the profile and the lower wall 138c is connected to this wall 126a and is wider than the upper wall so as to extend over a portion of the window.

In the example shown, the arm 138 has a general alteration shape with both longitudinal ends widened or oversized. The free longitudinal end of the arm 138 is thus oversized to accommodate a printed circuit board 139 that supports the camera. The lens of this camera is facing an orifice 140 of this longitudinal end of the arm, which is located on its rear wall 138a. As shown in FIG. 3b, the orifice 140 is located at the bottom of a basin of the wall 138a.

FIGS. 4a and 4b represent a second part of the support means which is in the form of a cover 142 intended to be attached and fixed, here by elastic snap-fastening, to the arm 138. The cover 142 is intended to close the arm 138 from the front. It thus has a general shape complementary to that of the arm. In particular, it has a general U-shaped cross-section and comprises a front wall 142a, and two side walls, respectively upper 142b and lower 142c.

The walls 142b and 142c comprise socket flanges 142d intended to cooperate with the walls 138b, 138c of the housing, and also include elastic snap-fastening tabs 144.

The cover 142 also has a general alteration shape with both longitudinal ends either widened or oversized. The longitudinal end of the cover, located on the side of the window 117, forms a base 145 or train intended to partially cover the window.

Although not visible, a cable to supply power to camera is connected at one end to the card 139 and at another end to an electrical connection plug. This cable can pass through an orifice 146 of the profile 126, opening into the inner cavity of the arm (FIG. 3a), and extend at least partially along the profile to exit through another orifice 148 of the profile (FIG. 2b). Thus, the camera is on an outer side of the window 117 while its plug is on an inner side of the window.

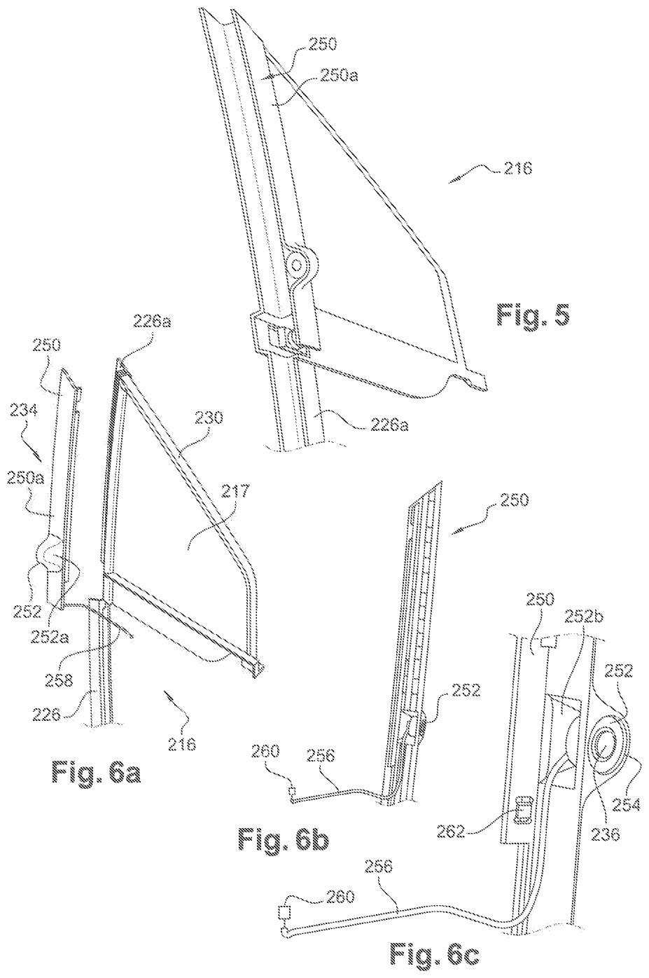

FIGS. 5 to 6c illustrate a second embodiment of the invention.

The sealing module 216 comprises a frame 230 surrounding a fixed window 217 and comprising at least one profile 226 extending along an edge of the window and extending beyond this edge to form a guide profile for guiding a sliding window of a vehicle door. The frame 230 comprises or is equipped with a seal that cooperates with the fixed window 217.

The window 217 here has a general trapezoidal shape but could have any other shape. The profile 226 extends along the large base of the window 117 and has a general U-shape cross-section over at least part of its height to define a longitudinal groove for receiving a slide vertical strand. Over the rest of its height, especially in the upper part, the profile 226 can have an L-shaped cross-section.

Means 234 for supporting an electronic equipment 236, such as a camera, are attached here and fixed to the frame 230 and more particularly to the profile 226.

These support means 234 are presented here in the form of an elongated shape hubcap 250 which is attached to a side wall 226a of the profile.

The hubcap 250 extends over part of the longitudinal dimension of the profile 226, corresponding to the visible part of the module 216 when mounted on a vehicle door framework.

The hubcap 250 comprises an outer surface 250a intended to be visible to a user. This outer surface comprises a recessed boss 252 in which the camera is housed. The lens of the camera is facing a rear opening 254 of the boss 252. The boss 252 defines an aerodynamic outer surface 252a, connected to the outer surface 250a of the hubcap.

The inner cavity 252b of the boss 252b is open towards the inside of the hubcap 250 to allow the passage of a cable 256 to supply power to the camera. This cable 256 extends partly along the hubcap and then passes through an opening 258 of the profile 226 so that its electrical connection plug 260 is located on an inner side of the module.

In the example shown, the hubcap 250 extends substantially over the entire height of the window 217, along a rear edge of the window. It can be attached to the profile 226 by elastic snap-fastening and thus comprise elastic snap-fastening tabs 262 distributed over its length.

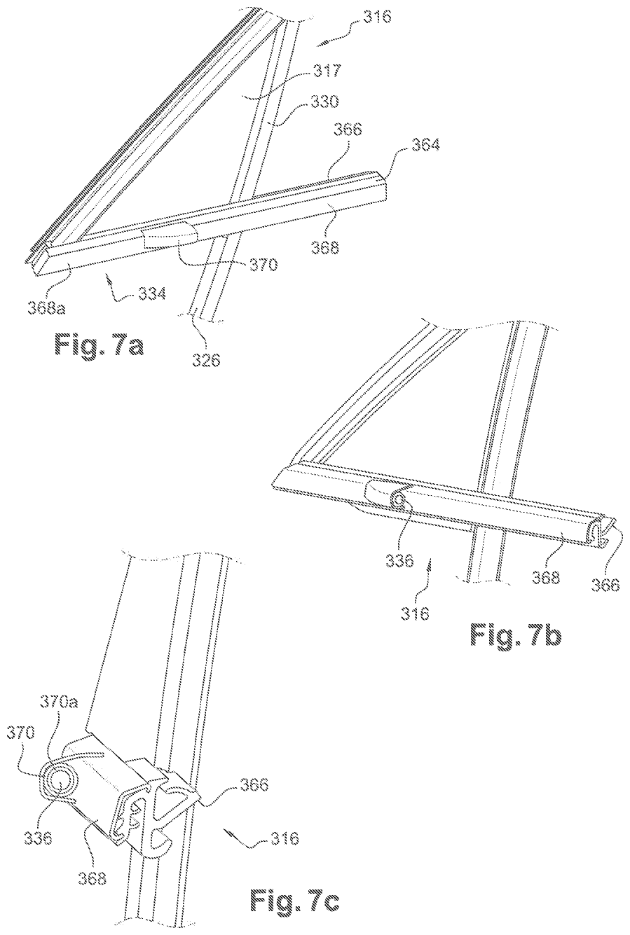

FIGS. 7a to 7c illustrate a third embodiment of the invention.

The sealing module 316 comprises a frame 330 surrounding a fixed window 317 and comprising at least one profile 326 extending along an edge of the window and extending beyond this edge to form a guide profile for guiding a sliding window of a vehicle door. The frame 330 comprises or is equipped with a seal that cooperates with the fixed window 317.

The window 317 here has a general triangular shape but could have any other shape. The profile 326 extends along one side of the window and has a general U-shaped cross-section to define a longitudinal groove for receiving a slide vertical strand.

Means 334 for supporting an electronic equipment 336, such as a camera, are attached here and fixed to the frame 330 and more particularly to a substantially horizontal edge of this frame.

These support means 334 are presented here in the form of a sealing strip 364 with an elongated shape which is attached to the aforementioned edge of the frame 330 and which extends in the extension of this edge, here towards the rear.

The sealing strip 364 comprises a seal 366 intended to cooperate with the window of the door, and a hubcap 368 to cover this seal.

The hubcap 368 comprises an outer surface 368a intended to be visible to a user. This outer surface 368a comprises a recessed boss 370 in which the camera is housed. The lens of the camera is facing a rear opening 370a of the boss. The boss 370 defines an aerodynamic outer surface, connected to the outer surface 368a of the hubcap.

The inner cavity of the boss 370 is open towards the inside of the hubcap to allow the passage of a cable to supply power to the camera, as mentioned above.

The hubcap 368 can be fixed to the frame 330 by elastic snap-fastening

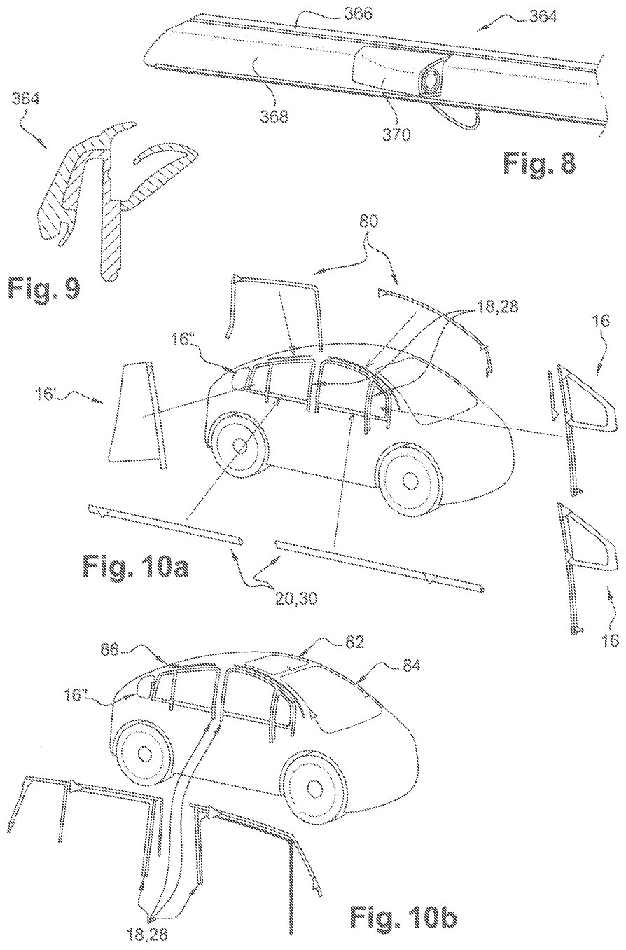

FIG. 8 illustrates another embodiment of the invention in which the sealing module is the sealing strip 364 alone. This sealing strip 364 comprises on the one hand a joint 366 intended to cooperate with a sliding window, and on the other hand a hubcap 368 forming a profile and carrying support means in the sense of the invention. The sealing strip 364 in FIG. 8 is similar to that in FIGS. 7a to 7c. The sealing strip 364 in FIG. 8 is intended to be mounted on a vehicle door independently of the fixed window module of that vehicle, while the sealing strip 364 in FIGS. 7a to 7c is mounted simultaneously with the fixed window module.

The sealing strip 364 described in the above can be made by attaching the hubcap 368 to the seal 366. The hubcap and seal can be made by extrusion, independently of each other. The hubcap can be made of metal.

Alternatively, they can be made by co-extrusion, injection, multi-injection, insert moulding, etc. This is particularly the case when the hubcap is made of thermoplastic material. FIG. 9 shows a monobloc sealing strip 364.

The sealing module according to the invention could still be a slide such as one of those 18, 28 shown in FIG. 1. This slide would then comprise at least one window seal and at least one profile, one of which would be integral with means for supporting an electronic equipment.

FIGS. 10a and 10b show schematically the locations of the electronic equipment on sealing modules of the vehicle using small triangles. As mentioned above, the sealing modules are of all types and for example modules 16, 16′ of fixed window on doors or body 16″ (in one part or two parts, i.e. with a cover attached or not), sealing strips 20, 30, slides 18, 28, frame seals 80 which provide a tightness between a door and the framework of the vehicle, opening roof seals 82, windscreen seals 84, rear window seals 86, etc.

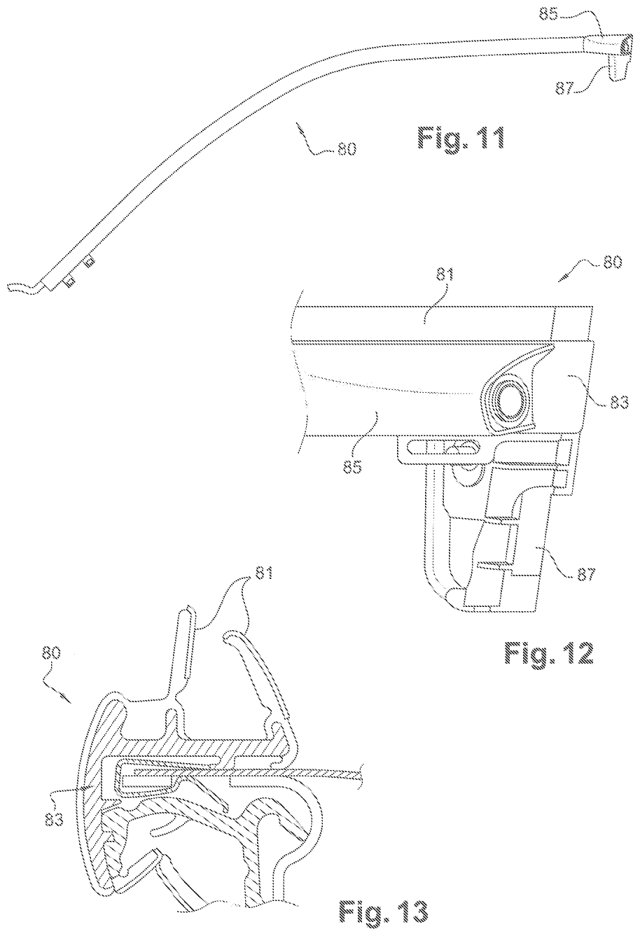

FIGS. 11 and 12 illustrate another embodiment of the invention in which the sealing module is a frame joint 80. The frame joint 80 has an elongated shape. It is intended to be mounted on a vehicle door and comprises at least one seal 81 intended to cooperate with the framework of the vehicle during the closing of the door. It also comprises an elongated profile 83, which can be produced simultaneously with the joint 81, for example by co-extrusion. The seal 81 can also be made by overmoulding on the profile, or assembled in a later operation. The frame joint 80 comprises at its downstream end support means 85 in the sense of the invention. These support means 85 are similar to those described in the above with reference to FIGS. 7a to 8. The support means 85 can be produced by bi-injection, extrusion, or overmoulding. The support means 85 are located on an outer side of the frame joint, at a fixing and indexing tab 87 located on an inner side of the frame joint 80. FIG. 13 shows a one-piece frame joint 80.

It is thus understood from the different embodiments of the invention that the sealing module 116, 216, 316 is pre-equipped with electronic equipment 136, 236, 336 such as a camera. This makes it easier to build a vehicle or a vehicle door because it is no longer necessary to mount this equipment on the door.

In practice, the construction of a vehicle door may include the steps of mounting the module 116, 216, 316 equipped with the camera on a framework of the door, and mounting the slide on the framework, for guiding the sliding window of the door. The support means 134, 234, 334 are located on an outer side of the door, and the electrical connection plug 260 of the camera is located on an inner side of said door.

Other types of electronic equipment such as a sensor, a radar, a turn signal repeater, etc., can also be used to pre-equip the sealing module according to the invention, in addition to or in place of the camera.

1. A sealing module for a motor vehicle, said module comprising:
at least one profile of at least partially elongated shape,
at least one seal configured to cooperate with an element of said vehicle, and
means for supporting at least one electronic equipment which is integral with or supported by said profile.

2. The module according to the preceding claim 1, wherein said seal extends at least partially along said profile.

3. The module according to claim 1, wherein said means for supporting includes a hubcap comprising at least one outer surface configured to be visible to a user of said vehicle.

4. The module according to claim 3, wherein said module is a window sealing strip, said seal being configured to cooperate with a sliding window of said vehicle.

5. The module according to claim 3, further comprising a boss on said outer surface, in which said electronic equipment is to be housed.

6. The module according to claim 1, wherein said profile and said seal are made by co-extrusion, multi-injection or overmolding, or are pre-assembled.

7. The module according to claim 1, wherein said module comprises a frame at least partially surrounding a fixed window, said profile being part of said frame or attached to said frame.

8. The module according to the claim 7, wherein said profile extends along an edge of said fixed window and extends beyond that edge to form a guide profile for guiding a sliding window of said vehicle.

9. The module according to claim 1, wherein said means for supporting is at least partially formed in one piece with said profile.

10. The module according to claim 1, wherein said means for supporting comprises a support arm which has a generally elongated shape and comprises a first longitudinal end connected to said profile and an opposite second longitudinal end in which said electronic equipment is to be housed.

11. The module according to claim 10, wherein the module comprises a cover attached to the arm and comprising a longitudinal portion extending along the arm and/or a base covering a part of said window.

12. The module according to claim 1, wherein the module further comprises an electronic equipment mounted on or in said means.

13. The module according to claim 12, wherein said electronic equipment comprises at least one sensor.

14. The module according to claim 13, wherein said electronic equipment comprises at least one optical sensor.

15. The module according to claim 12, wherein said electronic equipment is or comprises a camera, a turn signal repeater, a signal or information detection sensor, or a proximity radar.

16. The module according to claim 12, wherein said electronic equipment is connected to a first end of an electrical cable, an opposite second end of the electrical cable is connected to at least one electrical connection plug.

17. A method of manufacturing a motor vehicle, with a module according to claim 1, comprising a step of mounting said module equipped with said means for supporting, or even said electronic equipment, on a framework of said vehicle or of a door of said vehicle.

18. The method according to claim 17, wherein the method comprises a subsequent step of mounting a slide on said door framework, for guiding a sliding window of said door, said slide comprising a vertical strand fixed to said profile of said module.

19. The method according to claim 18, said module comprises an electronic equipment connected to a first end of an electrical cable, an opposite second end of the electrical cable is connected to at least one electrical connection plug, wherein said means for supporting is located on an outer side of said door, and said plug is located on an inner side of said door.

20. A motor vehicle, comprising at least one sealing module according to claim 1.
